(19) United States
(12) Patent Application Publication
(10) Pub. No.: US 2004/0199564 A1
(43) Pub. Date: Oct. 7, 2004

(54) Apparatus and method for multimedia data stream production

(76) Inventors: Shen Chih-Chiang, Taipei (TW); Olivier Brucker, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/692,989

(22) Filed: Oct. 24, 2003

(30) Foreign Application Priority Data
Apr. 3, 2003 (TW) 92107598

(51) Int. Cl. G06F 15/16

(52) U.S. Cl. 709/200

(57) ABSTRACT

An apparatus for producing multimedia data stream is disclosed. The inventive apparatus includes a virtual playback unit, a multitasking unit, and a data stream buffer unit. The virtual playback unit simulates the playback of multimedia data. The multitasking unit monitors the output of the virtual playback unit to adjust the allocation of video and audio data packs in the multimedia data stream dynamically.

### BACKGROUND OF THE INVENTION

1. Field of the Invention

The present invention relates to a multimedia data stream production technology, and in particular to an apparatus and method for multimedia data stream production in MPEG format.

2. Description of the Related Art

Recently, multimedia technology has developed rapidly as an application field in computer technology. Generally speaking, multimedia data combines text, pictures, video and audio data together, such as in VCD, DVD, SVCD, or MPEG (Motion Picture Experts Group) files for output. As an example, a multimedia player (i.e. a multimedia computer system) can decode and output the multimedia data.

The data structure of the multimedia data, such as MPEG format data, is illustrated in FIG. 1. The multimedia data stream 50 can be divided into video data packs 510 and audio data packs 520 according to data characteristics. In FIG. 1, V1, V2, . . . , indicate the order of the video data packs and the A1, A2, . . . , indicate the order of the audio data packs. The entire multimedia data stream 50 is recorded in a spiral track of a compact disk. Thus, the multimedia player can retrieve and decode the video data packs 510 and audio data packs 520 from the multimedia data stream 50 recorded in the compact disk.

The multimedia data stream 50 is produced by production software compatible with MPEG format. The production software encodes original source video and audio data stream separately into video data packs 510 and audio data packs 520. The produced video data packs 510 and the audio data packs 520 are integrated into the multimedia data stream 50.

FIG. 2 is a diagram illustrating a multimedia data stream played by a multimedia player. The player first acquires a multimedia data stream from a compact disk 160. The player then decodes the acquired multimedia data stream and stores the decoded video and audio data packs, i.e. V1, V2, . . . , A1, A2, . . . , in video data buffer 70 and audio data buffer 80 respectively. Finally, the stored video and audio data packs are sent to a display 90 and a speaker 100. Thus users can watch these multimedia data streams both with video and audio. Nevertheless, the allocation scheme of video and audio data packs in data stream of MPEG format is not strictly regulated. MPEG format production software may cause problems because of improper allocation of the video and audio data packs. For example, audio data and video data may not be synchronized when played.

More concretely, improper allocation of the video and audio data packs may cause audio output without images because there is no decoded video data pack in the video data buffer, or vice versa because there is no decoded audio data pack in the audio data buffer. In other words, if the data in the video buffer or the audio data buffer is insufficient, the problem of asynchronous playback may occur.

### SUMMARY OF THE INVENTION

Accordingly, an object of the invention is to provide a more stable method of multimedia data stream production. The inventive method adopts the concept of virtual playback, resolving the problems caused by improper allocation of the video and audio data packs.

To achieve the foregoing and other objects, the invention discloses an apparatus for multimedia data stream production. In one embodiment, the inventive apparatus comprises a virtual playback unit, a multitasking unit, and a data stream buffer unit. The virtual playback unit decodes a multimedia data stream and produces decoded video and audio data packs sequentially. The multitasking unit analyzes the decoded video and audio data packs, and decodes a source video data stream into a source video data pack or a source audio data stream into a source audio data pack according to the analysis. The data stream buffer unit stores video and audio data packs, which are produced from the multitasking unit, for integration into the multimedia data stream.

Moreover, the invention discloses a method for multimedia data stream production. The method first calculates playback time of a decoded video data pack and playback time of a decoded audio data pack. The inventive method then decodes a source video data stream into a source video data pack if the playback time of the decoded video data pack is less than the playback time of the decoded audio data pack. Alternately, the inventive method decodes a source audio data stream into a source audio data pack if the playback time of the decoded audio data pack is less than the playback time of the decoded data pack.

### BRIEF DESCRIPTION OF THE DRAWINGS

The present invention can be more fully understood by reading the subsequent detailed description and examples with references made to the accompanying drawings, wherein:

FIG. 1 is a diagram illustrating data in MPEG format.

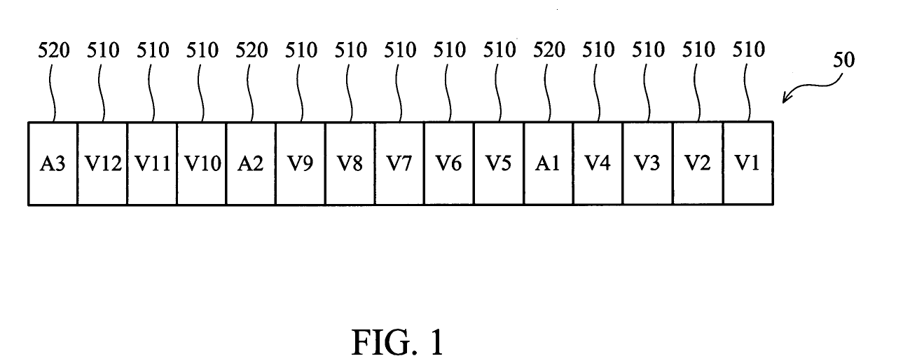

FIG. 2 is a diagram illustrating a multimedia data stream played by a multimedia player.

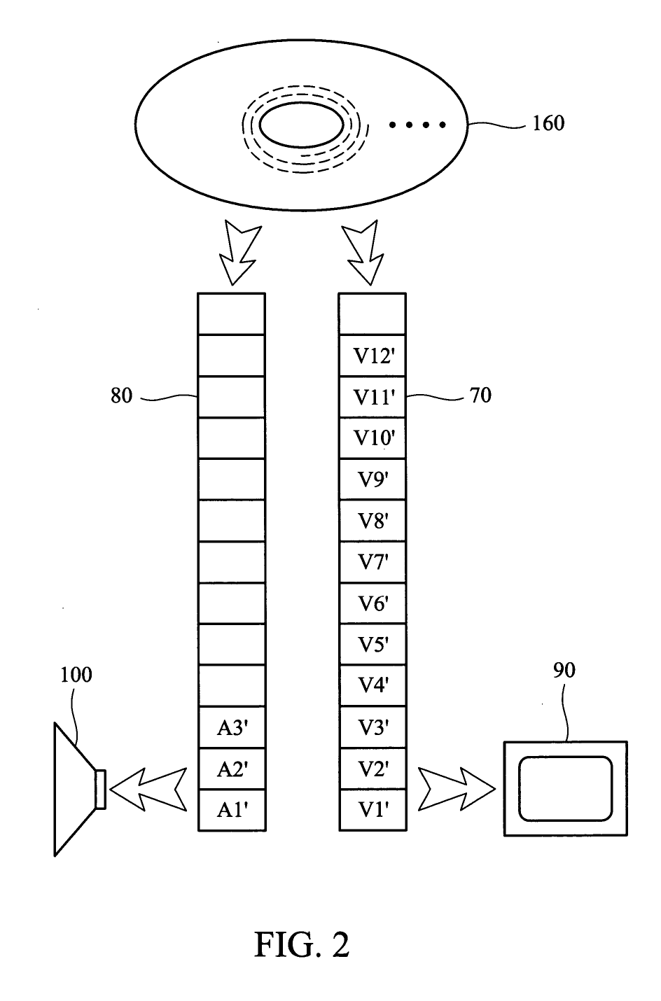

FIG. 3 is a diagram of the apparatus for multimedia data stream production.

FIG. 4 is a flowchart of the method for multimedia data stream production according to an embodiment.

### DETAILED DESCRIPTION OF THE INVENTION

As summarized above, the present invention is directed to apparatus and method for overcoming conventional asynchronous playback. In one embodiment, the inventive apparatus comprises a virtual playback unit, a multitasking unit, and a data stream buffer unit.

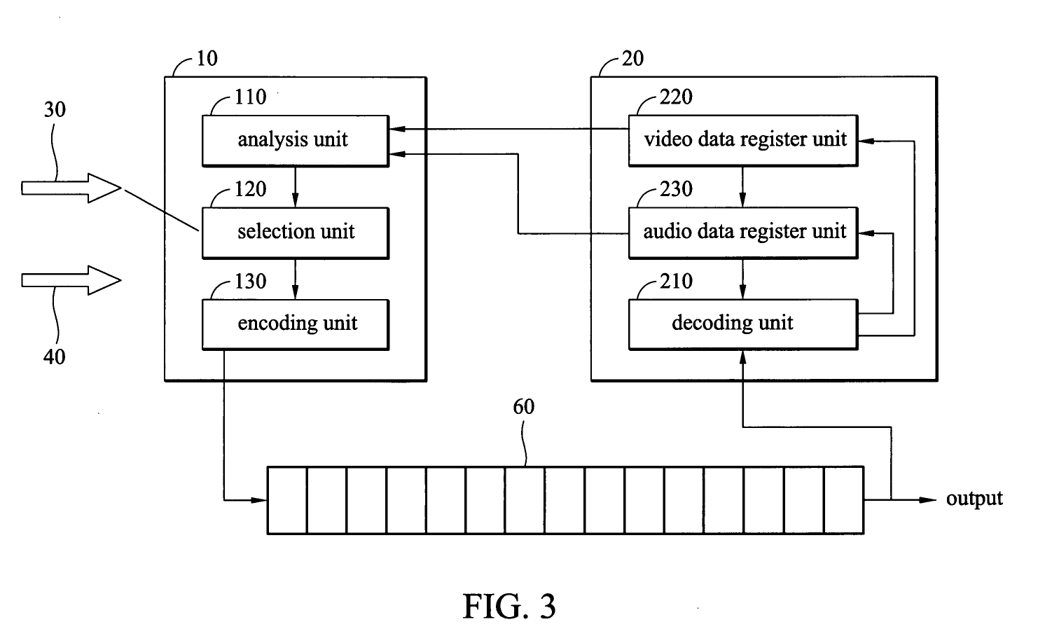

FIG. 3 is a diagram of the apparatus for multimedia data stream production according to the embodiment of the invention. A data stream is produced by multimedia data stream production software in MPEG format. The production software comprises a multitasking unit 10, a virtual playback unit 20, and a data stream buffer unit 60. The data stream buffer unit 60 stores the multimedia data stream produced by the multitasking unit 10. The virtual playback unit 20 simulates the standard multimedia player and provides a playback result to the multitasking unit 10. The multitasking unit 10 produces and integrates video data packs or audio data packs into the multimedia data stream according to the playback result from the virtual playback unit 20. The details of the multitasking unit 10 and the virtual playback unit 20 are described as follows.

The virtual playback unit of the embodiment comprises a decoding unit 210, a video data register unit 220, and an audio data register unit 230. The decoding unit 210 decodes the multimedia data stream from the data buffer unit 60 and retrieves the decoded video and audio data packs. The video data register unit 220 registers the decoded video data packs sequentially and the audio data register unit 230 registers the decoded audio data packs sequentially. The above steps are the same as those executed in a standard multimedia player, in which the decoded video and audio data packs are separated and output to the display and the speaker. In the virtual playback system, the decoded video and audio data packs are sent to the multitasking unit 10 for simulation rather than to the display and the speaker.

The multitasking unit 10 of the embodiment comprises an analysis unit 110, a selection unit 120, and an encoding unit 130. The analysis unit 110 analyzes the decoded video and audio data packs from the video register 220 and audio register unit 230 of the virtual playback unit 20 to produce an analysis result. The analysis result is sent to the selection unit 120. The selection unit 120 outputs source video data stream 30 or the source audio data stream 40 to the encoding unit 130 according to the analysis result. The encoding unit 130 receives source video data stream 30 or the source audio data stream 40 output from the selection unit 120. The encoding unit 130 also decodes the received source video data stream 30 or the source audio data stream 40 into source video data pack or the source audio data pack for integration into the data buffer unit 60.

As described above, the virtual playback unit 20 simulates the output of multimedia data. The multitasking unit 10 monitors the output of the virtual output unit to adjust the allocation of video and audio data packs in the multimedia data stream dynamically. In other words, the analysis unit 110 in the multitasking 10 can monitor the stored states of the video data register unit 220 and audio data register unit 230.

If the number of decoded video data packs in video data register 220 are less than the number of decoded audio data packs in the audio data register 230, the analysis result produced by the analysis unit 110 directs the selection unit 120 to receive source video data stream 30. The selected source video data stream 30 is sent to the encoding unit 130 to produce video data packs, integrated into the multimedia data stream thereafter.

On the other hand, if the number of the decoded audio data packs in the audio data register 230 are less than the number of the decoded video data packs in the video data register 220, the analysis result produced by the analysis unit 110 directs the selection unit 120 receive the source audio data stream 40. The selected source audio data stream 40 is sent to the encoding unit 130 to produce audio data packs, integrated into the multimedia data stream thereafter.

In addition, the inventive apparatus may include a storage unit (not illustrated in FIG. 3), the storage unit stores the multimedia data stream of the data stream buffer unit 60 into a storage medium sequentially.

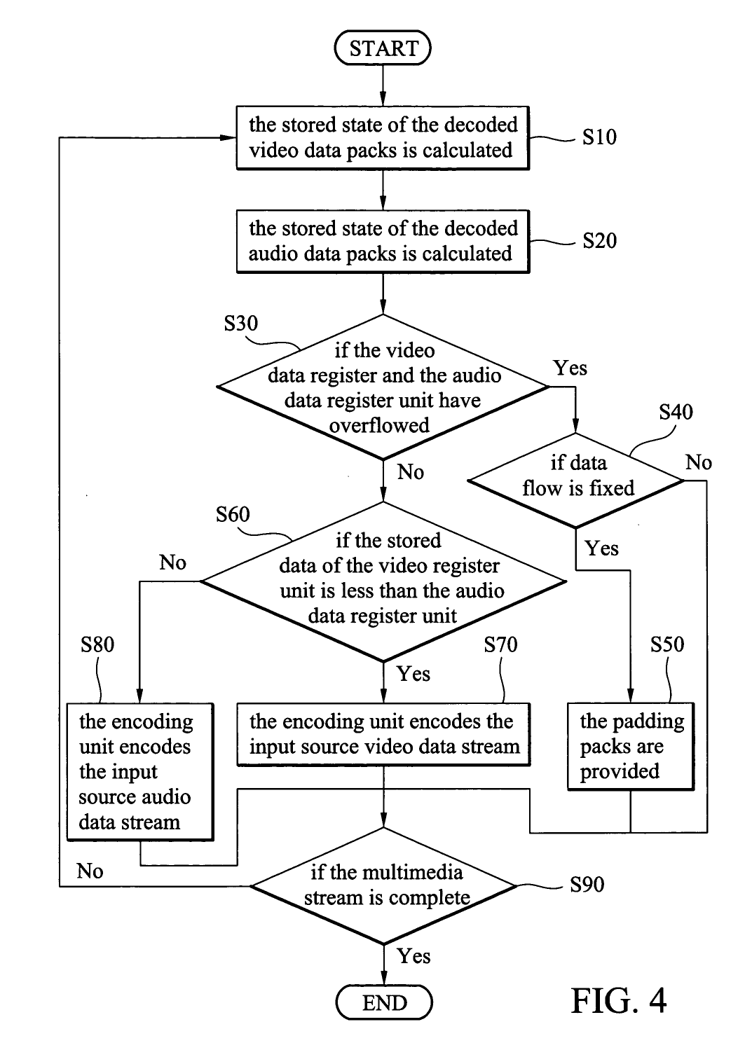

FIG. 4 is a flowchart of the method for multimedia data stream production according to the embodiment. The encoding unit 210 of the virtual playback unit 20 obtains the multimedia data stream from the data stream buffer unit 60, and retrieves the decoded video and audio data packs from the obtained multimedia data stream. The retrieved decoded video and audio data packs are stored in the video data register unit 220 and the audio data register unit 230 respectively for simulated playback. Meanwhile, the analysis unit 110 of the multitasking unit 10 analyzes the decoded video and audio data packs stored in the video data register unit 220 and the audio data register unit 230. The detailed steps of the analysis are described as follows.

The stored state of the decoded video data packs is calculated (step S10) as well as the stored state of the decoded audio data packs is calculated, too (step S20). Steps S10 and S20 respectively calculate the playback time of the decoded video and audio data packs stored in the video data register unit 220 and the audio data register unit 230. Here, fewer data packs indicate shorter playback time.

The analysis unit 110 determines whether the video data register 220 and the audio data register unit 230 have overflowed or not (step S30). If the video data register unit 220 and the audio data register unit 230 have not overflowed, the analysis unit 110 decides an analysis result according to the number of stored data packs. As an example, the analysis unit 110 determines if the number of the stored data packs in the video register unit 220 is less than those in the audio data register unit 230 (step S60).

If there is less stored data packs in the video data register 220 than in the audio data register unit 230, the playback time of the decoded video data packs is shorter than that of the audio data packs. Thus, data shortage may occur in the video data register unit 220. The multitasking unit 10 needs to encode and store source video data into the data stream buffer unit 60, avoiding the data shortage problem of the decoded video data packs. Thus, the selection unit 120 selects source video data stream 30 as input to the encoding unit 130. The encoding unit 130 encodes the input source video data stream (step S70) for integration into the data stream buffer unit 60.

Otherwise, if there is more stored data packs in the video data register 220 than in the audio data register unit 230, the playback time of the decoded video data packs is longer than the audio data packs. Thus, data shortage may occur in the audio data register unit 230. The multitasking unit 10 needs to encode and store the source audio data into the data stream buffer unit 60, avoiding the data shortage problem of the decoded audio data packs. Thus, the selection unit 120 selects the source audio data stream 40 as input to the encoding unit 130. The encoding unit 130 encodes the input source audio data stream (step S80) for integration into the data stream buffer unit 60.

The data allocation of the multimedia data stream may include padding packs in MPEG format. The padding packs comprise invalid data. If the padding packs are found in decoding process, the decoding unit 210 will ignore the padding packs and decode the next video or audio data pack. In step S30, if both the video and audio data register units have overflowed, the data flow is determined if it is fixed (step S40). If the data flow is fixed, the multimedia data stream must be output continuously. The padding packs are provided for data allocation of the multimedia data stream (step S50). If the data flow is not fixed, the padding packs are unnecessary.

Finally, it is determined if the multimedia stream is complete (step S90). If not, the method returns to step S10, or terminates.

Thus, the invention provides an apparatus and method to combine a virtual playback unit and a multitasking unit to identify and solve data shortages in the production of multimedia data streams. The invention resolve conventional asynchronous playback caused by improper allocation of the video and audio data packs.

It will be appreciated from the foregoing description that the apparatus and method described herein provide a dynamic and robust solution to asynchronous playback. If, for example, the disclosed production software in MPEG format is replaced by other software and/or hardware, the apparatus and method of the present invention can be revised to accommodate the change.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for multimedia data stream production, comprising:
a virtual playback unit, decoding a multimedia data stream into a plurality of decoded video data packs and a plurality of decoded audio data packs sequentially;
a multitasking unit, analyzing the decoded video data packs and the decoded audio data packs to decode a source video data stream into a source video data pack or a source audio data stream into a source audio data pack; and
a data stream buffer unit, storing the source video data pack and the source audio data pack for integration into the multimedia data stream.

2. The apparatus as claimed in claim 1, wherein the virtual playback unit further comprises:
a decoding unit, decoding the multimedia data stream and retrieving the decoded video data packs and the decoded audio data packs;
a video data register unit, registering the decoded video data packs sequentially; and
an audio data register unit, registering the decoded audio data packs sequentially.

3. The apparatus as claimed in claim 1, wherein the multitasking unit further comprises:
an analysis unit, analyzing the decoded video data packs and the decoded audio data packs to produce an analysis result;
a selection unit, outputting source video data stream or the source audio data stream according to the analysis result; and
an encoding unit, receiving source video data stream or the source audio data stream output from the selection unit, and decoding thereof into source video data pack or the source audio data pack.

4. The apparatus as claimed in claim 1, wherein the multitasking unit decodes source video data stream into source video data pack if the decoded video data packs are less than the decoded audio data packs in the virtual playback unit.

5. The apparatus as claimed in claim 1, wherein the multitasking unit decodes the source audio data stream into the source audio data pack if there are fewer decoded audio data packs than decoded video data packs in the virtual playback unit.

6. The apparatus as claimed in claim 1, further comprising a storage unit writing the multimedia data stream of the data stream buffer unit into a storage medium sequentially.

7. The apparatus as claimed in claim 1, wherein the apparatus is a production software.

8. A method for multimedia data stream production, comprising the steps of:
calculating playback time of a decoded video data pack;
calculating playback time of a decoded audio data pack;
decoding a source video data stream into a source video data pack if the playback time of the decoded video data pack is shorter than the playback time of the decoded audio data pack; and
decoding a source audio data stream into a source audio data pack if the playback time of the decoded audio data pack is longer than the output time of the decoded video data pack.

9. The method as claimed in claim 8, further comprising integrating the source video data pack and the source audio data pack sequentially into a multimedia data stream.

10. The method as claimed in claim 8, wherein the decoded video data pack and the decoded audio data pack are decoded from the multimedia data stream.
